(19) United States
(12) Patent Application Publication
(10) Pub. No.: US 2025/0000066 A1
(43) Pub. Date: Jan. 2, 2025

(54) Apparatus, method of making, and using a formicarium.

(71) Applicant: Erik Rodriguez, Escondido, CA (US)

(72) Inventor: Erik Rodriguez, Escondido, CA (US)

(21) Appl. No.: 18/214,594

(22) Filed: Jun. 27, 2023

(51) Int. Cl. A01K 63/00; A01K 67/033

(52) U.S. Cl. CPC A01K 63/003; A01K 67/033

(57) ABSTRACT

A formicarium apparatus may be made of at least one module wherein the module further is made of at least one base plate, at least three central nests, and at least one top layer, which are parallel to each other. The base plate may be at the bottom and top layer may be at the upper most surface, and the central nest/s may be sandwiched between the base plate and the top layer. The base plate and the top layer may be detachably attached to the at least three central nests by screws through screw-holes. The central nests may be perpendicular to each other. The module may further be made of interface connector, interface connector ports, interconnect adapter, hydration ports, and ventilation sections. The formicarium apparatus may be customizable and expandable in up to six directions with no or little ant escape.

### CROSS-REFERENCE TO RELATED APPLICATIONS

This Nonprovisional Application claims no benefit to any prior application.

### STATEMENT REGARDING FEDERALLY SPONSORED RESEARCH OR DEVELOPMENT

Not applicable.

The present disclosure relates to a formicarium that may be used to house and breed several ant colonies. The disclosure also provides methods of using, making, and expanding this unique formicarium.

### BACKGROUND

Formicarium is a structure where ants are housed. These formicaria are for display purposes and are intended for children to watch ants tunnel through the substrate. Although these formicaria are educational, they cannot be used for raising, breeding, and colonizing; thus, they are primarily used for housing non-breeding ants.

A formicarium disclosed herein may be used to house and breed several ant colonies. The disclosure also provides methods of using, making, and expanding this formicarium.

In this context, they are designed to house a breeding colony of ants, of which there are thousands of species. Ant keepers soon find the need to expand the nest area for their “pets” as they continue to grow and expand beyond the capacity of their current nest.

The current formicarium on the market is generally square in design, though sometimes round. They usually only have two or fewer connection ports, not designed to easily expand nest space as the species of ants being raised require more space for development. They also need to be more space and are not space-efficient on a desk. Another point is that all, if not most, formicarium on the market require the use of tubes and various T and + shaped tube connectors to expand nest space. This rapidly becomes impractical, messy, and prone to breakage, resulting in ants escaping.

### BRIEF DESCRIPTION OF THE INVENTION

The techniques described herein relate to the formicarium apparatus structure, method of use, and manufacture. The formicarium apparatus may include at least one module, wherein the module includes at least one base plate, at least one central nest, and at least one top layer wherein the base plate, the central nest, and the top layer may be parallel to each other; wherein the base plate may be at the bottom, the at least one central nest/s may be sandwiched between the base plate and the top layer; wherein the base plate and the top layer may be attached to the central nest/s by screws through screw-holes; wherein screws hold together the base plate, the central nest, and the top layer; and wherein the module may further including interface connector, interface connector port, hydration ports, interconnect adapter, and ventilation sections.

In some aspects, the techniques described herein relate to an apparatus, wherein at least two central nests are up to 180 degrees, for example, perpendicular to each other.

In some aspects, the techniques described herein relate to an apparatus, wherein the module may include at least one identical, non-identical, or both central nests.

In some aspects, the techniques described herein relate to an apparatus, wherein the module may include at least one identical, non-identical, or both.

In some aspects, the techniques described herein relate to an apparatus, wherein the ventilation section may include up to 130 holes arranged in any polygon shape, such as hexagon, triangular, rectangular/square, quadrilateral, pentagon, heptagon, octagon, nonagon, decagon, etc., and any combination thereof.

In some aspects, the techniques described herein relate to an apparatus, wherein the distance between two adjacent holes may be up to 10 mm.

In some aspects, the techniques described herein relate to an apparatus, wherein the holes may be up to 5 mm in diameter.

In some aspects, the techniques described herein relate to an apparatus, wherein the ventilation section may be up to 20 mm across.

In some aspects, the techniques described herein relate to an apparatus, wherein the ventilation section may be 20 mm in height.

In some aspects, the techniques described herein relate to an apparatus, wherein the module may be any polygon-shaped, such as hexagon, triangular, rectangular/square, quadrilateral, pentagon, heptagon, octagon, nonagon, decagon, etc., and any combination thereof.

In some aspects, the techniques described herein relate to an apparatus, wherein the hydration ports may be at least one.

In some aspects, the techniques described herein relate to an apparatus, wherein the water may be distributed through each hydration port by, for example, capillary action, suction, gravity, pressure, evaporation, condensation, precipitation, cohesion, adhesion, electrostatic, hydrophobic, hydrophilic, pump, which may be manual, mechanical, or automatic, etc., and any combination thereof.

In some aspects, the techniques described herein relate to an apparatus, wherein the module may include holes for the screws, wherein the screw holes may be 20 mm.

In some aspects, the techniques described herein relate to an apparatus, wherein the formicarium may be usable, lifetime, may have usable-shelf life, shelf-life usability from 1 to 30 years or for up to 30 years.

In some aspects, the techniques described herein relate to an apparatus, wherein the central nest houses ants or a subpopulation of ants selected one or more from a group consisting of eggs, larvae, pupae, drones, female alates, workers, queen, and any combination thereof.

In some aspects, the techniques described herein relate to an apparatus, wherein the apparatus may have a heater or may be connectable, detachably attached, or attachable-de-attachable to a heater. The heater may be the bottom of the apparatus.

In some aspects, the techniques described herein relate to an apparatus, wherein the central nest may include a coating of sand, mud or similar material.

In some aspects, the techniques described herein relate to an apparatus, wherein the coated sand may provide a surface for ants or ant sub-population to walk and/or grow.

In some aspects, the techniques described herein relate to an apparatus, wherein the coated sand may provide substrate for Larvae to properly encapsulate into Pupae.

In some aspects, the techniques described herein relate to the formicarium apparatus may include at least two modules, wherein the module may include: a base plate, a central nest, and a top layer; wherein the base plate, the central nest, and the top layer may be parallel to each other; wherein the base plate may be at the bottom, the at least three central nests may be sandwiched between the base plate and the top layer; wherein the base plate and the top layer may be attached to the central nest by screws; wherein screws may hold together the base plate, the central nest, and the top layer; and wherein the module may further include interface connector, hydration ports, and ventilation sections; wherein the apparatus may further include at least one interface connector on each side, and wherein the apparatus is expandable in six directions.

In some aspects, the techniques described herein relate to the formicarium apparatus including at least two modules

In some aspects, the techniques described herein relate to the formicarium apparatus, wherein the apparatus may be expandable in up to six directions.

In some aspects, the techniques described herein relate to an apparatus, wherein at least two interface connectors on at least two modules are configured to be connected by at least one interconnect adapter, wherein the two modules are adjacent to each other.

In some aspects, wherein the at least one interface connector on at least one module. The interface connector may be up to 130.

In some aspects, the techniques described herein relate to an apparatus, wherein the interconnect adapter may be up to 130.

In some aspects, the techniques described herein relate to the apparatus, wherein at least one interface connector of the module interface is closed off by at least one blocking adapter, wherein the blocking adapter is configured to prevent ant escape.

In some aspects, the techniques described herein relate to the apparatus, wherein one interface connector of the module interface may be connected to a test tube adapter to provide a connection for a test tube.

In some aspects, the techniques described herein relate to the apparatus, wherein at the at least one module may have at least one interface connector.

In some aspects, the techniques described herein relate to an apparatus, wherein the blocking adapter may be configured to provide ventilation, humidity, or both.

In some aspects, the techniques described herein relate to an apparatus, wherein one interface connector of the module interface may be connected to a tube adapter to provide a connection up to a 10 mm OD (outside diameter) tube.

In some aspects, the techniques described herein relate to an apparatus, wherein the tube may be connected to an outworld or another formicarium.

In some aspects, the techniques described herein relate to an apparatus, wherein one interface connector of the module interface may be connected to a test tube adapter to provide a connection to a test tube.

In some aspects, the techniques described herein relate to an apparatus, wherein one interface connector of the module interface may be connected to a tube adapter to provide a connection to a 10 mm outside diameter tube.

In some aspects, the techniques described herein relate to an apparatus, wherein the tube may be connected to an outworld or another formicarium.

### BRIEF DESCRIPTION OF THE FIGURES

FIG. 1A is a schematic of the top view of the base plate.

FIG. 1B shows an isometric view of the base plate.

FIG. 2B is a top view of the central nest.

FIG. 2 B shows an isometric view of the nest.

FIG. 3A. is a top view of the top layer.

FIG. 3B shows an isometric view with the plate.

FIG. 3Ba is a top view of red cover layer on the top layer.

FIG. 3Bb shows an isometric view with the plate.

FIG. 4A is a side view of interconnect adapter.

FIG. 4B is a top view of interconnect adapter.

FIG. 4C is an isometric view of the interconnect adapter.

FIG. 5A is a top view of interface connector.

FIG. 5B is a side view of interface connector.

FIG. 5C is isometric view of interface connector.

FIG. 6A is a side view of a blocker adapter.

FIG. 6B is a top view of a blocker adapter.

FIG. 6C is an isometric view of a blocker adapter.

FIG. 7A is a side view of a tube adapter.

FIG. 7B is a top view of a tube adapter.

FIG. 7C is an isometric view of a tube adapter.

FIG. 8Aa is a side view of an assembled formicarium.

FIG. 8Ab is an isomeric view of an assembled formicarium.

FIG. 8B is an isometric view of an assembled formicarium.

FIG. 8C is a rendering view of an assembled formicarium.

### DETAILED DESCRIPTION OF THE INVENTION

Examples of embodiments are provided so that this disclosure will be thorough and fully convey the scope to those skilled in the art. Numerous specific details are set forth, such as examples of specific components, devices, and methods, to provide a thorough understanding of the embodiments and various aspects of the present disclosure. It will be apparent to those skilled in the art that specific details need not be employed, that example embodiments may be embodied in many different forms, and that neither should be construed to limit the scope of the disclosure. In some example embodiments, well-known processes, device structures, and technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

The preceding summary, as well as the following detailed description of certain embodiments or aspects, will be better understood when read in conjunction with the appended figures. As used herein, an element or step recited in the singular and proceeded with the word “a” or “an” should be understood as not excluding the plural of said elements or steps unless such exclusion is explicitly stated. Furthermore, references to “one embodiment,” “an embodiment,” “one aspect,” or “an aspect” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning or definition.

The purpose of this disclosure is to provide a unique formicarium structure, and method of using and making the said formicarium structure for housing, growing, raising, breeding, and colonizing ants, wherein the starting ant may be from one or more queens.

The techniques described herein relate to the formicarium apparatus structure may include at least one module, wherein the module including: at least one base plate (for example, 1, 2, 3, 4, 5, 6, 7, 8, 9, 10, 11, 12, 13, 14, 15, 16, 17, 18, 19, 20, etc.), at least one central nest (for example, 1, 2, 3, 4, 5, 6, 7, 8, 9, 10, 11, 12, 13, 14, 15, 16, 17, 18, 19, 20, etc.), and at least one top layer (for example, 1, 2, 3, 4, 5, 6, 7, 8, 9, 10, 11, 12, 13, 14, 15, 16, 17, 18, 19, 20, etc.); wherein the base plate, the central nest, and the top layer may be parallel to each other; wherein the base plate may be at the bottom, the at least one (for example, 1, 2, 3, 4, 5, 6, 7, 8, 9, 10, 11, 12, 13, 14, 15, 16, 17, 18, 19, 20, etc.) central nest/s may be sandwiched between the base plate and the top layer; wherein the base plate and the top layer may be attached to the central nest/s by screws through screw-holes; wherein the base plate, the central nest, and the top layer are held together by screws; and wherein the module may further including interface connector, interface connector port, hydration ports, interconnect adapter, and ventilation sections.

In some aspects, the techniques described herein relate to an apparatus, wherein at least two central nests are up to 180 degrees, for example, perpendicular to each other. The degrees between the two or more central nests may be up to 180, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103,104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, etc., and any combination thereof.

In some aspects, the techniques described herein relate to an apparatus, wherein the module may include at least one identical, non-identical, or both central nests. The central nest/s may be 1, 2, 3, 4, 5, 6, 7, 8, 9, 10, 11, 12, 13, 14, 15, 16, 17, 18, 19, 20, etc., and any combination thereof.

In some aspects, the techniques described herein relate to an apparatus, wherein the module may include at least one identical, non-identical, or both ventilation sections. The ventilation sections may be 1, 2, 3, 4, 5, 6, 7, 8, 9, 10, 11, 12, 13, 14, 15, 16, 17, 18, 19, 20, etc., and any combination thereof.

In some aspects, the techniques described herein relate to an apparatus, wherein the ventilation section may include up to 130 holes arranged in any polygon shape, such as hexagon, triangular, rectangular/square, quadrilateral, pentagon, heptagon, octagon, nonagon, decagon, and any combination thereof. The number of holes may be up to 130 per ventilation section or per module, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, etc., and any combination thereof.

In some aspects, the techniques described herein relate to an apparatus, wherein the distance between two adjacent holes may be up to 10 mm, for example, 0.1, 0.2, 0.3, 0.4, 0.5, 0.6, 0.7, 0.8, 0.9. 1.0, 1.1, 1.2, 1.3, 1.4, 1.5, 1.6, 1.7, 1.8, 1.9. 2, 2.1, 2.2, 2.3, 2.4, 2.5, 2.6, 2.7, 2.8, 2.9. 3, 3.1, 3.2, 3.3, 3.4, 3.5, 3.6, 3.7, 3.8, 3.9. 4, 4.1, 4.2, 4.3, 4.4, 4.5, 4.6, 4.7, 4.8, 4.9. 5, 5.1, 5.2, 5.3, 5.4, 5.5, 5.6, 5.7, 5.8, 5.9. 6.0, 6.1, 6.2, 6.3, 6.4, 6.5, 6.6, 6.7, 6.8, 6.9. 7.0, 7.1, 7.2, 7.3, 7.4, 7.5, 7.6, 7.7, 7.8, 7.9. 8.0, 8.1, 8.2, 8.3, 8.4, 8.5, 8.6, 8.7, 8.8, 8.9. 9.0, 9.1, 9.2, 9.3, 9.4, 9.5, 9.6, 9.7, 9.8, 9.9. 10 mms, etc., and any combination thereof.

In some aspects, the techniques described herein relate to an apparatus, wherein the holes may be up to 5 mm in diameter, for example, 0.5, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.5, 5 mm, etc.

In some aspects, the techniques described herein relate to an apparatus, wherein the ventilation section may be up to 20 mm across, for example, 0.5, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.5, 5, 5.5, 5.1, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, 14, 14.1, 14.2, 14.3, 14.5, 14.6, 14.7, 14.8, 14.9, 15, 15.1, 15.2, 15.3, 15.4, 15.5, 15.6, 15.7, 15.8, 15.9, 16, 16.1, 16.2, 16.3, 16.4, 16.5, 16.6, 16.7, 16.7, 16.8, 16.9, 17, 17.1, 17.2, 17.3, 17.4, 17.5, 17.6, 17.7, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20 mm, etc., and any combination thereof.

In some aspects, the techniques described herein relate to an apparatus, wherein the ventilation section may be 20 mm in height, for example, 0.5, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.5, 5, 5.5, 5.1, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, 14, 14.1, 14.2, 14.3, 14.5, 14.6, 14.7, 14.8, 14.9, 15, 15.1, 15.2, 15.3, 15.4, 15.5, 15.6, 15.7, 15.8, 15.9, 16, 16.1, 16.2, 16.3, 16.4, 16.5, 16.6, 16.7, 16.7, 16.8, 16.9, 17, 17.1, 17.2, 17.3, 17.4, 17.5, 17.6, 17.7, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20 mm, etc., and any combination thereof.

In some aspects, the techniques described herein relate to an apparatus, wherein the module may be any polygon-shaped, such as hexagon, triangular, rectangular/square, quadrilateral, pentagon, heptagon, octagon, nonagon, decagon, etc., and any combination thereof.

In some aspects, the techniques described herein relate to an apparatus, wherein the hydration ports may be at least one, for example, 1, 2, 3, 4, 5, 6, 7, 8, 9, 10, 11, 12, 13, 14, 15, 16, 17, 18, 19, 20, etc., and any combination thereof.

In some aspects, the techniques described herein relate to an apparatus, wherein the water may be distributed through each hydration port by, for example, capillary action, suction, gravity, pressure, evaporation, condensation, precipitation, cohesion, adhesion, electrostatic, hydrophobic, hydrophilic, pump, which may be manual, mechanical, or automatic, etc., and any combination thereof.

In some aspects, the techniques described herein relate to an apparatus, wherein the module may include holes for the screws, wherein the screw holes may be 20 mm, for example, 0.5, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.5, 5, 5.5, 5.1, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, 14, 14.1, 14.2, 14.3, 14.5, 14.6, 14.7, 14.8, 14.9, 15, 15.1, 15.2, 15.3, 15.4, 15.5, 15.6, 15.7, 15.8, 15.9, 16, 16.1, 16.2, 16.3, 16.4, 16.5, 16.6, 16.7, 16.7, 16.8, 16.9, 17, 17.1, 17.2, 17.3, 17.4, 17.5, 17.6, 17.7, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20 mm, etc., and any combination thereof.

In some aspects, the techniques described herein relate to an apparatus, wherein the formicarium may be usable, lifetime, may have usable-shelf life, shelf-life usability from 1 to 30 years or for up to 30 years, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, etc.

In some aspects, the techniques described herein relate to an apparatus, wherein the central nest houses ants or a subpopulation of ants selected one or more from a group consisting of eggs, larvae, pupae, drones, female alates, workers, queen, and any combination thereof.

In some aspects, the techniques described herein relate to an apparatus, wherein the apparatus may have a heater or may be connectable, detachably attached, or attachable-de-attachable to a heater. The heater may be the bottom of the apparatus.

In some aspects, the techniques described herein relate to an apparatus, wherein the central nest may include a coating of sand, mud or similar material.

In some aspects, the techniques described herein relate to an apparatus, wherein the coated sand may provide a surface for ants or ant sub-population to walk and/or grow.

In some aspects, the techniques described herein relate to an apparatus, wherein the coated sand may provide substrate for Larvae to properly encapsulate into Pupae. In some aspects, the techniques described herein relate to the formicarium apparatus may include at least two modules, wherein the module may include: a base plate, a central nest, and a top layer; wherein the base plate, the central nest, and the top layer may be parallel to each other; wherein the base plate may be at the bottom, the at least three central nests may be sandwiched between the base plate and the top layer; wherein the base plate and the top layer may be attached to the central nest by screws; wherein screws may hold together the base plate, the central nest, and the top layer; and wherein the module may further include interface connector, hydration ports, and ventilation sections; wherein the apparatus may further include at least one interface connector on each side, and wherein the apparatus is expandable in six directions.

In some aspects, the techniques described herein relate to the formicarium apparatus including at least two modules, for example 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, or more modules.

In some aspects, the techniques described herein relate to the formicarium apparatus wherein the apparatus may be expandable in up to six directions (for example, 1, 2, 3, 4, 5, 6 directions).

In some aspects, the techniques described herein relate to an apparatus, wherein at least two interface connectors on at least two modules are configured to be connected by at least one interconnect adapter, wherein the two modules are adjacent to each other.

In some aspects, wherein the at least one interface connector on at least one module. The interface connector may be up to 130, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, etc.

In some aspects, the techniques described herein relate to an apparatus, wherein the interconnect adapter may be up to 130, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, etc.

In some aspects, the techniques described herein relate to the apparatus, wherein at least one interface connector of the module interface is closed off by at least one blocking adapter, wherein the blocking adapter is configured to prevent ant escape.

In some aspects, the techniques described herein relate to the apparatus, wherein one interface connector of the module interface may be connected to a test tube adapter to provide a connection for a test tube.

In some aspects, the techniques described herein relate to the apparatus, wherein at the at least one module may have at least one interface connector, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, etc.

In some aspects, the techniques described herein relate to an apparatus, wherein the blocking adapter may be configured to provide ventilation, humidity, or both.

In some aspects, the techniques described herein relate to an apparatus, wherein one interface connector of the module interface may be connected to a tube adapter to provide a connection up to a 10 mm OD (outside diameter) tube; for example, 0.1, 0.2, 0.3, 0.4, 0.5, 0.6, 0.7, 0.8, 0.9. 1.0, 1.1, 1.2, 1.3, 1.4, 1.5, 1.6, 1.7, 1.8, 1.9. 2, 2.1, 2.2, 2.3, 2.4, 2.5, 2.6, 2.7, 2.8, 2.9. 3, 3.1, 3.2, 3.3, 3.4, 3.5, 3.6, 3.7, 3.8, 3.9. 4, 4.1, 4.2, 4.3, 4.4, 4.5, 4.6, 4.7, 4.8, 4.9. 5, 5.1, 5.2, 5.3, 5.4, 5.5, 5.6, 5.7, 5.8, 5.9. 6.0, 6.1, 6.2, 6.3, 6.4, 6.5, 6.6, 6.7, 6.8, 6.9. 7.0, 7.1, 7.2, 7.3, 7.4, 7.5, 7.6, 7.7, 7.8, 7.9. 8.0, 8.1, 8.2, 8.3, 8.4, 8.5, 8.6, 8.7, 8.8, 8.9. 9.0, 9.1, 9.2, 9.3, 9.4, 9.5, 9.6, 9.7, 9.8, 9.9. 10, mms, and any combination thereof.

In some aspects, the techniques described herein relate to an apparatus, wherein the tube may be connected to an outworld or another formicarium.

In some aspects, the techniques described herein relate to an apparatus, wherein one interface connector of the module interface may be connected to a test tube adapter to provide a connection to a test tube.

In some aspects, the techniques described herein relate to an apparatus, wherein one interface connector of the module interface may be connected to a tube adapter to provide a connection to a 10 mm outside diameter tube.

In some aspects, the techniques described herein relate to an apparatus, wherein the tube may be connected to an outworld or another formicarium.

The formicarium of the disclosure is typically relatively small, where ant keepers house their ants, and the formicarium keepers may also raise their ants from single, or up to 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 50, 100, 150, 200, etc., queen ant(s) to full grown colonies.

One or all formicarium parts may be fabricated from the same or different materials, for example, plastic, Acrylic, Polycarbonate, glass, Acrylonitrile Butadiene Styrene (ABS Filament), Polyethylene, Polyamide (Nylon Filament), Thermoplastic Polyurethane (TPU Filament), Polyactic Acid (PLA Filament), Phthalates (Resin), Methyl Methacrylate (Resin), Acrylic Acid (Resin), etc., and any combination thereof.

In some aspects, the formicarium and/or parts thereof may be fabricated using plastic, Acrylic, Polycarbonate, glass, Acrylonitrile Butadiene Styrene (ABS Filament), Polyethylene, Polyamide (Nylon Filament), Thermoplastic Polyurethane (TPU Filament), Polyactic Acid (PLA Filament), Phthalates (Resin), Methyl Methacrylate (Resin), Acrylic Acid (Resin), any other commercial or customized resin, or any combination thereof.

The formicarium is designed with layers of plastic, Acrylic, Polycarbonate, glass, Acrylonitrile Butadiene Styrene (ABS Filament), Polyethylene, Polyamide (Nylon Filament), Thermoplastic Polyurethane (TPU Filament), Polyactic Acid (PLA Filament), Phthalates (Resin), Methyl Methacrylate (Resin), Acrylic Acid (Resin) to provide a secure area for the ant inhabitants. This is constructed with at least one module that in turn may be made of at least three components, namely, a base plate, a central nest, and a top layer.

The base plate, in combination with the top layer, binds the formicarium into a single structure with the nest in the middle and is referred to herein as a module. The base plate may provide a bottom surface and supporting structure for the Formicarium.

The base plate may be above the external surface it rests on. This configuration may allow the ant keeper to provide low, medium, or maximum heat to the formicarium, which may be necessary for most inhabitant species.

In some aspects, heat may be provided by additional heating devices. For example, a heating cable, a heating mat, heater, heating-coil, infrared heater, water-heater, etc. or any combination thereof. The formicarium may have two or more acorn nuts, for example 2, 3, 4, 5, 6, 7, 8, 9, 10, 11, 12, etc. under the formicarium. These acorn nuts may provide sufficient space between the base plate of the formicarium and the underlying surface such as a table/counter/shelf the formicarium may be sitting on to allow for a proper placement of a heating device.

In some aspects, the apparatus, or parts thereof may be compatible, integrable, and facilitated to provide heat to the apparatus via one or more heating devices, for example, 1, 2, 3, 4, 5, 6, 7, 8, 9, 10, 11, 12, 13, 14, 15, 16, 17, 18, 19, 20, or more.

In some aspects, the base plate may be attached securely to the central nest via a securing mechanism, which may or may not be detached, attachable, re-attachable, such as glue, screws, nails, Cyanoacrylate Esters (Super Glue), Cyanoacrylate (Glass glue), Methyl Methacrylate (Polycarbonate Glue), any adhesive, etc., and any combination thereof. The attachment mechanism may hold the apparatus together.

In some aspects, one, two, or all three components of the module, namely the base plate, the top plate, and the central nest may be fabricated as one piece without a requirement for an attachment mechanism to hold the module, the apparatus, or parts thereof together.

In some aspects, one, two, or all three module components, namely the base plate, the top plate, and the central nest may be fabricated using an FDM or MLSA 3D printer. However, these monolithic modules may require additional components or elements to properly facilitate hydration because these modules may or may not need additional elements for the water to flow through.

In some aspects, the base plate may have holes cut into it for the screws. For example, the screw holes may be M2×18 hex nut head.

In some aspects, the base plate may have a minimum number of holes up to 22 holes, for example, 2, 3, 4, 5, 6, 7, 8, 9, 10, 11, 12, 13, 14, 15, 16, 17, 18, 19, 20, 21, 22 holes.

In some aspects, the maximum number of holes per base plate may be 2 times the number of middle layer components, for example for every one central nest component there may be two holes, for every 4 holes per 2 central nest components 6 holes per 3 components, 8 holes per 4 components, 10 holes per 5 components, 12 holes per 6 components, 14 holes per 7 components, 16 holes per 8 components, 18 holes per 9 components, 20 holes per 10 components, so on and so forth.

In some aspects, each hole may be up to 5 mm in diameter, for example, 0.5, 1.0, 1.5, 2, 2.2, 2.5, 3, 3.5, 4, 4.5, 5 mm in diameter.

In some aspects, each hole may fit M2×18 hex nut head.

The base plate may be made of any material that is transparent, translucent, semi-translucent, semi-opaque, opaque, tinted, etc., and any combination thereof, so that light or partial light may be transferred gently through the layer and provide illumination for observation from one, two, three, four, five, six, seven, eight, nine, ten, or any combination thereof sides of the apparatus. The base plate color may be the same or different from other apparatus parts.

The center nest may be made of one, two, three, four, five, six, seven, eight, nine, ten, or more central nest components. These two, three, or more (at least two) components may provide a central nest that locks onto the interface component. Each of these two (at least two) components may have at least two holes drilled in them that match the position of the holes on the bottom/base plate and top layer places. These screws or other securing mechanisms may allow for the secure placement of these components and prevent them from rotating or moving out of position. These components may be of the same or different sizes. Another unique feature may be that the central nest may be where the interface connectors lock into place. The interface connectors may allow for the adapters to be used to interlock new formicarium modules, close off the port, allow the ant keeper to connect the formicarium to third-party formicarium and/or outworlds, etc., or any combination thereof.

In some aspects, each of the six sides may have block adaptors, for example, 1, 2, 3, 4, 5, 6, 7, 8, 9, 10, 11, 12 sides on each side. Each side may facilitate the use of a blocking adapter, test tube adapter, tube adapter or an interconnect adapter. The choice may depend on the needs of the ant Keeper. At least one adapter may be used for each side at any given time, and these may be easily interchangeable.

In some aspects, each of the six sides may have test tube adaptors, for example, 1, 2, 3, 4, 5, 6, 7, 8, 9, 10, 11, 12 sides. These may be used to move a colony because the ant keeper may attach a test tube adapter; thereafter, attach the test tube containing the colony to the formicarium module.

In some aspects, each of the six sides may have tube adaptors, for example, 1, 2, 3, 4, 5, 6, 7, 8, 9, 10, 11, 12 sides. The ant keeper may attach a tube adapter, then connect a 10 mm outer diameter tube to this adapter then to an Outworld (which may be a third party or not) to provide the colony foraging space.

In some aspects, each of the six sides may have tube adaptors, for example, 1, 2, 3, 4, 5, 6, 7, 8, 9, 10, 11, 12 sides. The ant keeper may attach a tube adapter, then connect a 10 mm outer diameter tube to this adapter then to a Formicarium module, which may or may not be of a third party.

In some aspects, each of the six sides may have interconnect adaptors, for example, 1, 2, 3, 4, 5, 6, sides. The ant keeper may attach an interconnect adapter between the first Formicarium module to a second Formicarium module. This may lock the two or more modules in place, thus expanding the formicarium.

The top layer may provide additional features that benefit the ant inhabitants and assist the ant keeper in maintaining a proper environment. These features include at least three, for example, 3, 4, 5, 6, 7, 8, 9, 10, or more areas that contain a matrix of small holes for ventilation. The top layer may contain at least three, for example, 3, 4, 5, 6, 7, 8, 9, 10, or more, small holes to allow the ant keeper to add water as needed, which may be necessary for the health of the inhabitants. This top layer is designed to be transparent, thus allowing the ant keeper to view the ant activities within the formicarium to observe the health, growth, and development of the ant inhabitants.

In some aspects, the two pieces, at least two, may have a water port to provide for the hydration of the ants. These pieces may be larger of the pieces.

In some aspects, to complete the apparatus, one or more of the central nest layers may be stacked. For example, three copies may be stacked of two pieces, totaling six pieces. The one layer may be duplicated two more times to provide three layers, completing the nest inter-design.

In some aspects, three stacks may provide adequate space for most species of ants to live in and feel comfortable, and also provide a reservoir suitable space to store water for hydration.

Above the central nest, the top layer may be secured. This top layer may be similar, identical, or different than the bottom layer in size and structure. The securing mechanism may be the same as the base plate, for example, concerning the holes for the M2 bolts.

The top layer may be made of plastic, Acrylic, Polycarbonate, glass, Acrylonitrile Butadiene Styrene (ABS Filament), Polyethylene, Polyamide (Nylon Filament), Thermoplastic Polyurethane (TPU Filament), Polyactic Acid (PLA Filament), Phthalates (Resin), Methyl Methacrylate (Resin), Acrylic Acid (Resin) or any combination thereof. This top layer contains no pigments, which may or may not be the same as the base plate, central nest, or both.

In some aspects, the top layer may be made of at least three additional holes drilled into it positioned over where the hydration ports may be positioned on the middle layers. This water source may seep through the layers via capillary action.

In some aspects, the hydration ports may be filled with fibers, resins, cotton, or any water-absorbing or water-holding materials; any non-toxic and absorbent material that may be able to retain and release water may be used in the hydration chamber. for example, cotton balls, cotton fibers, sponge, cloth, sand, etc., and any combination thereof.

In some aspects, the top layer may have a matrix of small holes drilled into it to provide ventilation to the nest. There may be two, three, four, five, six, seven, eight, nine, ten, or any combination thereof areas where this ventilation is provided.

In an aspect, the Formicarium may have 1, 2, 3, 4, 5, 6, 7, 8, 9, 10, or more hydration areas referred to herein as hydration ports. These ports may be filled with cotton that the ant keeper may fill with purified water. The water may seep through the any layers (plastic, Acrylic, Polycarbonate, glass, Acrylonitrile Butadiene Styrene (ABS Filament), Polyethylene, Polyamide (Nylon Filament), Thermoplastic Polyurethane (TPU Filament), Polyactic Acid (PLA Filament), Phthalates (Resin), Methyl Methacrylate (Resin), Acrylic Acid (Resin), etc., and any combination hereof) and increase the humidity within the formicarium. This water may also provide a water source for the ants residing within the formicarium.

In an aspect, the cotton in the hydration ports may be up to 5 gm, for example, 0.01, 0.2, 0.3, 0.4, 0.5, 0.6, 0.7, 0.8, 0.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 5.1, 4.2, 4.3, 4.4, 4.5, 4.6, 4.7, 4.8, 4.9, 50 gm, etc., and any combination thereof.

In some aspects, the hydration ports may be customizable, and the ant keeper may use one or more hydration port/s for humidity or selectively allow the port/s to remain dry. This may provide the ant keeper the ability to manage and adjust the hydration levels within the formicarium depending upon species and the number of ants. Ant species may have different hydration requirements and may vary from species to species.

In some aspects, the hydration port structure, distribution, number, etc., may allow one or more port/s to remain dry while one or more port/s remain hydrated simultaneously. Customizable hydration may assist in reducing the possibility of growing mold, which may be detrimental to a healthy ant colony.

In some aspects, the hydration ports may be rotatably hydrated and remain dry to reduce the probability of mold growth.

In some aspects, the top layer may have airflow sections (ventilation section). For example, 1, 2, 3, 4, 5, 6, 7, 8, 9, 10, or more airflow sections that allow air to enter the nest. Together the hydration ports and airflow sections help the ant keeper to balance airflow with humidity levels, thus improving the internal formicarium environment to better suit the species of ant being kept.

In some aspects, a cover may be placed on the top layer. Because most ant species are sensitive to light and may become stressed in light, but cannot see red, this red cover allows the Keeper to observe the inhabitants without disturbing them. This cover is easily placed and removed without the use of any tools. This cover may also provide an aesthetic appearance and add to the functionality of the formicarium.

In some aspects, the holes drilled into the red cover may match the holes on the bottom layer. However, the diameter of these holes may be slightly larger than similar holes in the other layers, for example the top layer, that allows the cover to fit over the screws. The slightly larger holes may allow for the top of the bolt to fit through, thus, allowing the red cover to fit flush with the transparent top layer. The top layer may also contain the hole matrix that are positioned and aligned with the top layer ventilation holes. This allows the nest to be properly vented even with the red cover in place. This layer may or may not contain hydrations holes similar to the top layer. When present the holes may be continuous or not with the holes in the top layer.

This cover may be red, pink, blue, yellow, green, orange, white, black, any primary or secondary color, tinted, opaque, transparent, clear, etc., and any combination thereof.

In some aspects, a cover may be attached, de-attachable attached, placed, etc., or any combination thereof to the top layer, central nest, or both.

In some aspects, the holes in the red cover may be drilled into this cover to match the holes on the central nest, base plate, or both. However, the diameter of these holes allows the cover to fit over the screw nuts of the top layer of the module. Furthermore, the top layer may also contain the hole matrix positioned and aligned with the top layer ventilation holes. This may allow the nest to be properly vented even with the red cover in place. This cover may or may not contain hydrations holes like the top layer. The ventilation holes in the red cover may be aligned with the ventilation holes on the transparent top to allow for airflow; without these holes the airflow may be blocked.

In some aspects, the cover holes may fit over the screws on this cover may be up to 5 mm in diameter, for example, 0.5, 1, 1.5, 2. 2.5, 3, 3.5, 3.6, 3.7, 3.8, 3.9, 4.0, 4.1, 4.2, 4.3, 4.4, 4.5, 5 mm in diameter.

In some aspects, the ventilation holes may be precisely the same number and size as the holes in the top layer.

In some aspects, each module may have up to 20 ventilation sections, for example, 1, 2, 3, 4, 5, 6, 7, 8, 9, 10, 11, 12, 13, 14, 15, 16, 17, 18, 19, 20 ventilation sections and any combination thereof.

In some aspects, each ventilation section may have up to 50 holes, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, and any combination thereof.

In some aspects, each hole may be up to 5 mm in diameter, for example, 0.1, 0.2, 0.3, 0.4, 0.5, 0.6, 0.7, 0.8, 0.9. 1.0, 1.1, 1.2, 1.3, 1.4, 1.5, 1.6, 1.7, 1.8, 1.9. 2, 2.1, 2.2, 2.3, 2.4, 2.5, 2.6, 2.7, 2.8, 2.9. 3, 3.1, 3.2, 3.3, 3.4, 3.5, 3.6, 3.7, 3.8, 3.9. 4, 4.1, 4.2, 4.3, 4.4, 4.5, 4.6, 4.7, 4.8, 4.9. 5 mms, and any combination thereof.

In some aspects, each hole may be away from another adjacent hole by up to 10 mm in diameter, for example, 0.1, 0.2, 0.3, 0.4, 0.5, 0.6, 0.7, 0.8, 0.9. 1.0, 1.1, 1.2, 1.3, 1.4, 1.5, 1.6, 1.7, 1.8, 1.9. 2, 2.1, 2.2, 2.3, 2.4, 2.5, 2.6, 2.7, 2.8, 2.9. 3, 3.1, 3.2, 3.3, 3.4, 3.5, 3.6, 3.7, 3.8, 3.9. 4, 4.1, 4.2, 4.3, 4.4, 4.5, 4.6, 4.7, 4.8, 4.9. 5, 5.1, 5.2, 5.3, 5.4, 5.5, 5.6, 5.7, 5.8, 5.9. 6.0, 6.1, 6.2, 6.3, 6.4, 6.5, 6.6, 6.7, 6.8, 6.9. 7.0, 7.1, 7.2, 7.3, 7.4, 7.5, 7.6, 7.7, 7.8, 7.9. 8.0, 8.1, 8.2, 8.3, 8.4, 8.5, 8.6, 8.7, 8.8, 8.9. 9.0, 9.1, 9.2, 9.3, 9.4, 9.5, 9.6, 9.7, 9.8, 9.9. 10, mms, and any combination thereof.

In some aspects, each hole may have a wide of 100 mm in diameter, for example, 0.1, 0.2, 0.3, 0.4, 0.5, 0.6, 0.7, 0.8, 0.9. 1.0, 1.1, 1.2, 1.3, 1.4, 1.5, 1.6, 1.7, 1.8, 1.9. 2, 2.1, 2.2, 2.3, 2.4, 2.5, 2.6, 2.7, 2.8, 2.9. 3, 3.1, 3.2, 3.3, 3.4, 3.5, 3.6, 3.7, 3.8, 3.9. 4, 4.1, 4.2, 4.3, 4.4, 4.5, 4.6, 4.7, 4.8, 4.9. 5, 5.1, 5.2, 5.3, 5.4, 5.5, 5.6, 5.7, 5.8, 5.9. 6.0, 6.1, 6.2, 6.3, 6.4, 6.5, 6.6, 6.7, 6.8, 6.9. 7.0, 7.1, 7.2, 7.3, 7.4, 7.5, 7.6, 7.7, 7.8, 7.9. 8.0, 8.1, 8.2, 8.3, 8.4, 8.5, 8.6, 8.7, 8.8, 8.9. 9.0, 9.1, 9.2, 9.3, 9.4, 9.5, 9.6, 9.7, 9.8, 9.9. 10, 10.1, 10.2, 10.3, 10.4, 10.5, 10.6, 10.7, 10.8, 10.9. 20, 20.1, 20.2, 20.3, 20.4, 20.5, 20.6, 20.7, 20.8, 20.9. 30, 30.1, 30.2, 30.3, 30.4, 30.5, 30.6, 30.7, 30.8, 30.9. 40, 40.1, 40.2, 40.3, 40.40, 40.5, 40.6, 40.7, 40.8, 40.9. 50, 50.1, 50.2, 50.3, 50.4, 50.5, 50.6, 50.7, 50.8, 50.9. 60.0, 60.1, 60.2, 60.3, 60.4, 60.5, 60.6, 60.7, 60.8, 60.9. 70.0, 70.1, 70.2, 70.3, 70.4, 70.5, 70.6, 70.7, 70.8, 70.9. 80.0, 80.1, 80.2, 80.3, 80.4, 80.5, 80.6, 80.7, 80.8, 80.9. 90.0, 90.1, 90.2, 90.3, 90.4, 90.5, 90.6, 90.7, 90.8, 90.9. 100 mms, and any combination thereof.

In some aspects, each hole may have a height of 100 mm in diameter, for example, 0.1, 0.2, 0.3, 0.4, 0.5, 0.6, 0.7, 0.8, 0.9. 1.0, 1.1, 1.2, 1.3, 1.4, 1.5, 1.6, 1.7, 1.8, 1.9. 2, 2.1, 2.2, 2.3, 2.4, 2.5, 2.6, 2.7, 2.8, 2.9. 3, 3.1, 3.2, 3.3, 3.4, 3.5, 3.6, 3.7, 3.8, 3.9. 4, 4.1, 4.2, 4.3, 4.4, 4.5, 4.6, 4.7, 4.8, 4.9. 5, 5.1, 5.2, 5.3, 5.4, 5.5, 5.6, 5.7, 5.8, 5.9. 6.0, 6.1, 6.2, 6.3, 6.4, 6.5, 6.6, 6.7, 6.8, 6.9. 7.0, 7.1, 7.2, 7.3, 7.4, 7.5, 7.6, 7.7, 7.8, 7.9. 8.0, 8.1, 8.2, 8.3, 8.4, 8.5, 8.6, 8.7, 8.8, 8.9. 9.0, 9.1, 9.2, 9.3, 9.4, 9.5, 9.6, 9.7, 9.8, 9.9. 10, 10.1, 10.2, 10.3, 10.4, 10.5, 10.6, 10.7, 10.8, 10.9. 20, 20.1, 20.2, 20.3, 20.4, 20.5, 20.6, 20.7, 20.8, 20.9. 30, 30.1, 30.2, 30.3, 30.4, 30.5, 30.6, 30.7, 30.8, 30.9. 40, 40.1, 40.2, 40.3, 40.40, 40.5, 40.6, 40.7, 40.8, 40.9. 50, 50.1, 50.2, 50.3, 50.4, 50.5, 50.6, 50.7, 50.8, 50.9. 60.0, 60.1, 60.2, 60.3, 60.4, 60.5, 60.6, 60.7, 60.8, 60.9. 70.0, 70.1, 70.2, 70.3, 70.4, 70.5, 70.6, 70.7, 70.8, 70.9. 80.0, 80.1, 80.2, 80.3, 80.4, 80.5, 80.6, 80.7, 80.8, 80.9. 90.0, 90.1, 90.2, 90.3, 90.4, 90.5, 90.6, 90.7, 90.8, 90.9. 100 mms, and any combination thereof

In some aspect, the formicarium apparatus may be its ability to expand. This formicarium allows for potentially up to 3000 expandability in one-, two-, or three-dimensional space. As the ant colony grows and develops, more nest space may be needed for further growth. Because the ant keeper may simply, quickly, and easily attach more nests allowing for estimable growth of the ants. The estimable growth may depend upon and allow the colony to continue growing as long as the Queen remains alive. Colonies can grow into tens of thousands of members. This growth may also depend upon the colony development, or as much growth as the ant keeper wants or needs. This capability may be due to the hex shape of the nest, which is the most space-efficient geometric shape for the purpose of this apparatus. The interface and interconnect adapters may allow the ant keeper to attach and lock on new nest modules quickly.

In some aspects, the formicarium apparatus may be its ability to expand. This formicarium allows for potentially up to 3000 expandability in one-, two-, or three-dimensional space. The limitation for expandability may be counter/table/shelf/room/building, etc., space. The structural composition of the module and the component may facilitate vertical, horizontal, tangential (any angular degrees, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103,104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380 degrees, or any fraction thereof) oblique, etc., or any combination of these expansion of the formicarium via a central column that the individual (at least two or more) formicarium may lock onto, and each column may stack on the previous module. This central column may de-attachable-attach to the modules, each other, or both.

In some aspects, the formicarium may be attached to expand up to 3000 modules, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103,104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503,504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 650, 700, 750, 800, 850, 900, 950, 1000, 1050, 1100, 1150, 1200, 1250, 1300, 1350, 1400, 1450, 1550, 1600, 1650, 1700, 1800, 1850, 1900, 1950, 2000, 2500, 2600, 2700, 2800, 2900, 3000, etc., and any combination thereof.

In some aspects, the formicarium may be arranged in several patterns that suit the keeper's needs. Moreover, because the formicarium modules are uniform in size and shape, the ant keeper can add as many, or as few formicarium as needed.

In some aspects, this formicarium may be wall mounted. The placement of the formicarium on the wall (vertical or horizontal in height) may depend upon the species of ant being housed because some ants have a hard time climbing vertical surfaces compared to other ant species.

In some aspects, the formicarium may be used to enhance or add to the aesthetic of an area or room. The formicarium may be arranged around a mirror, or family pictures, etc.

In some aspects, the formicarium apparatus uses space efficiently due to the hex shape and the use of connectors and adaptors of this disclosure, for example, the T and X tube adapters.

In some aspects, the Hex shape may be added to the internal optional use of internal formicarium space allocated to the ant's use. Further, the interface and the interlock adapter formicarium may be connected to adjacent nests using less than 2 cms between them, for example, 0.1, 0.2, 0.3, 0.4, 0.5, 0.6, 0.7, 0.8. .9, 1, 1.1, 1.2, 1.3. 1.4, 1.5, 1.6, 1.7, 1.8, 1.9, 2 cm, or any combination thereof.

In some aspects, the connectors and adaptors ensure that each module or any component of the apparatus may not be disconnected accidentally.

In some aspects, the formicarium module may be connected on 1, 2, 3, 4, 5, 6, 7, 8, 9, 10, 11, 12, or greater sides.

In some aspects, the formicarium may allow the keeper to close ports using the blocker adapter that prevents ants from escaping while allowing airflow.

In some aspects, the interconnect adapter may allow for quick connection and locking from one Formicarium to another easily. These may be just as easily disconnected and moved elsewhere. There may be a special adapter that allows the keeper to connect the formicarium to modules of this disclosure herein or an Outworld (An area the ants will forage for food, water, sugars, hunt, and dispose of refuse.).

An Outworld may be an area that is attached to a Formicarium that allows the ants to scavenge for food, water, nectar, and other necessities for life. An outworld may be also an area where the ants dispose of waste materials. These materials may consist of dead ants, waste from insects they ate, shells of hatched ants, and any other material that the ants may not want inside their nest.

The tube adapter may quickly lock into any formicarium interface ports and allows the keeper to connect up to a 20 mm outside diameter (OD) tube connected to an outworld, or a formicarium of a 3rd party design. For example, 1, 2, 3, 4, 5, 6, 7, 8, 9, 9.5, 10. 10.5, 11, 11.5, 12, 13, 14, 15, 16, 17, 18, 19, 20 mm, or any combination thereof.

In some aspects, the formicarium modules may easily and quickly connect to any (the disclosure formicarium or another) formicarium by using a small adapter that inserts into the two neighboring formicarium. The assembly method may be by a simple twist, locking both into place. Formicarium modules may be easily detached by reversing these steps. To prevent the ants from flowing out, the inhabiting ants may be removed before disconnecting the modules.

In some aspects, each side of the formicarium may have a component designed to connect the formicarium to another formicarium, close off the connection, or connect the formicarium to a tube. This component is referred to herein as the Interface, and the pieces that connect to the interface are referred to as adapters.

The adapters may be of one or more types, interconnect adapter, blocking adapter, tube adapter, etc., and any combination thereof.

Interconnect adapter may be an adapter designed to interlock at least two formicarium modules together securely.

Interlock adapter may be inserted into the interface connector between two formicarium and with a simple twist using the supplied wrench, locks them together, thus easily allowing the ant keeper to expand the available nest space rapidly and easily for the inhabitants as they outgrow their existing nest space. This is a key design feature in this product as it eliminates and simplifies several concerns ant Keepers have with all other designs on the market.

In most cases, not all six Interface Connectors may be used at any given time, so the ant keeper may insert a Blocking Adapter into position and lock it in place with a simple twist using the provided wrench. This may prevent the ant inhabitants from escaping while also providing ventilation. Blocking Adapter may be an adapter that closes off the Interface, preventing ants from escaping while allowing airflow through the formicarium. In the event the ant keeper may not need to use an interface on one side, the ant keeper may make use of the Blocking Adapter.

In some aspects, the interface Connector and all adapters may be fabricated from 3-dimensional printing using one or more materials, such as resin. For example, using a high resolution MSLA (masked stereolithography apparatus) 3D printer, SLA (stereolithography) 3D printer. The printing may or may not involve selectively curing photosensitive resin with or without LCD power source. The curing may be successive layered and cured upon the previous ones, forming a three-dimensional structure.

Tube Adapter may be an adapter that allows the ant keeper to connect the Formicarium via a connect up to a 20 mm Outside diameter (OD) tube to formicarium of module of the disclosure herein or another third-party designs, test tubes, outworlds, or any other device the ant keeper use connected to an outworld, or a formicarium of a 3rd party design. For example, 1, 2, 3, 4, 5, 6, 7, 8, 9, 9.5, 10. 10.5, 11, 11.5, 12, 13, 14, 15, 16, 17, 18, 19, 20 mm, any fraction thereof and any combination thereof.

Due to the design of the Formicarium and the Interconnect Adapter, the space between the interconnected formicarium is less than 5 cm, for example, 0.1, 0.2, 0.3, 0.4, 0.5, 0.6, 0.7, 0.8, 0.9. 1.0, 1.1, 1.2, 1.3, 1.4, 1.5, 1.6, 1.7, 1.8, 1.9. 2, 2.1, 2.2, 2.3, 2.4, 2.5, 2.6, 2.7, 2.8, 2.9. 3, 3.1, 3.2, 3.3, 3.4, 3.5, 3.6, 3.7, 3.8, 3.9. 4, 4.1, 4.2, 4.3, 4.4, 4.5, 4.6, 4.7, 4.8, 4.9. 5 cm, and any combination thereof.cm, reinforcing the space-efficient design.

In an aspect, the formicarium may provide more nest space in the one, two, three dimensional and any combination thereof space per centimeter square than any other completive.

In some aspects, the formicarium may use space effectively due to the unique geometrical structure of the disclosure herein.

In some aspects, the formicarium may use space effectively due to the unique structure connecting two or more formicarium modules of the disclosure herein. There may be equal or less than 2 cm, for example, 0.1, 0.2, 0.3, 0.4, 0.5, 0.6, 0.7, 0.8, 0.9, 1, 1.1, 1.2, 1.3, 1.4, 15, 1.6, 1.7, 1.8, 19, 2, or any fraction thereof, gap between individual formicarium modules when they are all locked together.

In some aspects, the distance between the modules may be up to 5 cm, for example, 0.1, 0.2, 0.3, 0.4, 0.5, 0.6, 0.7, 0.8, 0.9. 1.0, 1.1, 1.2, 1.3, 1.4, 1.5, 1.6, 1.7, 1.8, 1.9. 2, 2.1, 2.2, 2.3, 2.4, 2.5, 2.6, 2.7, 2.8, 2.9. 3, 3.1, 3.2, 3.3, 3.4, 3.5, 3.6, 3.7, 3.8, 3.9. 4, 4.1, 4.2, 4.3, 4.4, 4.5, 4.6, 4.7, 4.8, 4.9. 5 cm, and any combination thereof.

In some aspects, the hex-shaped structure of the module may allow for each nest to be attached to six, for example, 1, 2, 3, 4, 5, 6, additional nests while providing minimal wasted space (Less than 2 cm between the modules, thus making the most of available space due to the connection system and geometry of the nest.

Implementing the connection of one Formicarium module of this disclosure to another (of this disclosure or a third party) may be rapid and may be completed within a couple seconds, for example, 0.5, 1, 1.5, 2, 2.5, 3, 3.5, 4, 4.5, 5, 10, 15, 20, 25, 30, 35, 40, 45, 50, 55, 60, 70, 80, 90, 100, 120, 130, 140, 150, 160, 170, 180 seconds, etc., and any combination thereof. This quick connection may result in zero to very few escaped ants, and also greatly reduces the possibility of damaging or killing one or ants.

Furthermore, the formicarium of disclosure herein may not require the use of tubes to expand the formicarium by connecting two or more (at least two) modules. When the tubes are used, they require measuring and cutting tubes, connecting the tubes. These connected tubes typical do not stay connected, which squeezes the tubing into the formicarium. This can cause stress for the colony resulting in the ants running around rapidly looking for the disturbance. The ants often lead to escapees, ants getting injured, and the ant keeper suffering bites and stings, which can be quite painful. The disclosure herein may prevent these sequences of events leading to ants to escape and injury to the ant keeper.

In some aspects, the formicarium may have an internal nest coated with fine sand, sand, mud, and other similar materials. Besides, serving as a cosmetic or aesthetic design, sand or similar materials may provide a substrate for ants to walk. Some species can walk on smooth substrates, whiles others need rough surfaces to walk. The formicarium of this disclosure provides walking surfaces for all ant species. Additionally, pupae from some species require a rough/sand-like substrate to build their cocoon. The sand coating, therefore, may provide a cocoon-building function necessary for the colony's success and development.

In some aspects, the formicarium of this disclosure may house several ant species, there are 13,800 known ant species and the formicarium may house one or more of ant species, for example, Carpenter ants—Camponotus Sp, the black garden ant Lasius niger, the harvester ant Messor barbarous, and the red ant Myrmica rubra, Lasius niger, the harvester ant Messor, Mesor, Lasius, Servibrmnica, Solenopsis, Crematogaster, Canponolus, Myrmeciinae, Camponotus Consobrinus, Inidomyrmex purpureus, Mynnecia pyriformis, Myrmecia forficata, Aphaenogaster fulva, Aphaenogaster lamellidens, Aphaenogaster occidentalis, Aphaenogaster picea, Aphaenogaster rudis, Aphaenogaster tennesseensis, Aphaenogaster texana, Apaenogaster Sp., Brachymyrmex depilis, Brachymyrmex obscurior, Brachymyrmex patagonicus, Brachymyrmex Sp., Camponotus americanus, Camponotus anthrax, Camponotus caryae, Camponotus castaneus, Camponotus chromaiodes, Camponotus decipiens, Camponotus essigi, Camponotus floridanis, Camponotus fragilis, Camponotus herculeanus, Camponotus hyatti, Camponotus impressus, Camponotus laevigatus, Camponotus mississipiensis, Camopnotus modoc, Camopnotus nearcticus, Camponotus novaeboracensis, Camponotus obliquus, Camponotus ocreatus, Camponotus pennsylvanicus, Camponotus planatus, Camponotus quercicola, Camponotus sansabeanus, Camponotus semitestaceus, Camponotus sexguttatus, Camponotus socius, Camponotus subbarbatus, Camponotus tortuganus, Camponotus vicinus, Camponotus yogi, Camponotus Sp. 1, Camponotus Sp., Cardiocondyla mauritanica, Cardiocondyla Sp., Crematogaster ashmeadi, Crematogaster cerasi, Crematogaster depilis, Crematogaster lineolata, Crematogaster mutans, Crematogaster Sp. 1, Crematogaster Sp. 2, Crematogaster Sp. 3, Crematogaster Sp. 4, Crematogaster Sp. 5, Crematogaster Sp. 6, Crematogaster Sp. 7, Crematogaster Sp., Cyphomyrmex minutus, Cyphomyrmex rimosus, Cyphomyrmex Sp., Dolichoderus plagiatus, Dolopomyrmex plagiatus, Dorymyrmex bicolor, Doryrnyrmex bureni, Dorymyrmex insanus, Dorymyrmex Sp. 1, Dorymyrmex Sp., Forelius pruinosus, Forelius Sp., Formical asserva, Formica biophilica, Formica exsectoides, Formica FRANCOEURI, Formica fusca, Formica ilacialis, Formica incerta, Formica integra, Formica integroides, Formica moki, Formica neogagates, Formica obscuripes, Formica obscuriventris, Formica pacifica, Formica pallidefulva, Formica podzolica, Formica ravida, Formica rubicunda, Formica subaenescens, Formica transmontanis, Formica ulkei, Gnamptogenys triangularis, Hypoponera opacior, Hypoponera punctatissima, Hypoponera Sp., Lasius alienus, Lasius claviger, Lasius flavus, Lasius interjectus, Lasius latipes, Lasius myrphyi, Lasius nearcticus, Lasius neoniger, Lasius niger, Lasius pallitarsus, Lasius subumbratus, Lasius umbratus, Lasius Sp. 1, Lasius Sp. 2, Lasius Sp. 3, Lasius Sp., Leptogenys elongata, Leptothorax acervoruim, Leptothorax muscorum, Leptothorax Sp., Linepithema humile, Lipmetopum luctusum, Lipmtcrpum occidentale, Manica Sp., Monomorium ergatogyna, Monemorium floricola, Monomorium minimum, Myrmecina americana, Myrmica pinetorum, Myrmica punctiventris, Myrmica rubra, Myrmica scabrinodis, Myrmica speciodies, Myrmica Sp., Neivamyrmex nigerescens, Neivamyrmex swainsonii, Neivamyrmex Sp., Novomessor cockerelli, Nylanderia faisonensis, Nylanderia flavipes, Nylanderia parvula, Nylanderia terricola, Nylanderia vividula, Nylanderia Sp., Odontomnachus clarus, Odontomachus Sp., Pheidole bicarinata, Pheidole californica, Pheidole dentata, Pheidole dentigula, Pheidole desertcorum, Pheidole flavens, Pheidole floridana, Pheidole gilvescens, Pheidole hyatti, Pheidole megacephala, Pheidole morerens, Pheidole moerens, Pheidole navigans, Pheidole obscurithorax, Pheidole pilifera, Pheidole tysoni, Pheidole vaslitii, Pheidole vistana, Phelidole xerophila, Pheidole Sp. 1, Pheidole Sp. 2, Pheidole Sp. 3, Pheidole Sp., Pogonomyrmex badius, Pogonomyrmex barbatus, Pogonomyrmex californicus, Pogonomyrmex magnacanthus, Pogonomyrmex montanus, Pogonomyrmex occidentalis, Pogonomyrmnex rogosus, Pogonomyrmex salinus, Pogonomyrmex subdentatus, Pogonomyrmex subnitidus, Pogonomyrmex teniuspinus, Pogonomyrrmex Sp., Polyergus breviceps, Polyergus lucidus, Polyergus mexicanus, Polyergus topoffi, Polyergus vinosus, Polyergus Sp., Ponera pennsylvanica, Ponera Sp., Prenolepis imparis, Proceratium chickasaw, Proceratium silaceum, Pseudomyrmex apache, Pseudomyrmex caeciliae, Pseudomyrmex ejectus, Pseudomyrmex gracilis, Pseudonyrmnex Sp., Solenopsis amblychila, Solenopsis geminata, Solenopsis invicta, Solenopsis molesta, Solenopsis pergandei, Solenopsis tennesseensis, Solenopsis texana, Solenopsis truncorum, Solenopsis xyloni, Solenopsis Sp., Stigmatominma pallipes, Strumigenys Sp., Syscia augustae, Tapinoma sessile, Temnothorax andrei, Temnothorax caguatan, Temnothorax curvispinosus, Temnothorax Sp. 1, Temnothorax Sp. 2, Temnothorax Sp., Tetramorium atratulus, Tetramorium bicarinatum, Tetramoriumt caespithum, Tetramorium tsushimae, Tetramorium Sp., Trachymyrmex septentrionalis, Veromessor andrei, Veromessor pergandei, etc., and combination thereof.

In some aspects, the formicarium may house ants or subpopulation of ants, for example, workers, male, female, queen/s, eggs, larvae, pupae, drones, female alates, queen and any combination thereof at the same or different times.

In some aspects, a queen may live for up to 30 years; thus, the formicarium of this disclosure may have a life-time, usability, or usable-shelf life of up to 30 years. However, workers may live from 1 to 3 years, and males, may be more transitory, short-lived, and survive for only a few weeks. The formicarium of the disclosure may be used from few weeks to several years, for example, 1, 2, 3, 4, 5, 6, 7, 8, 9, 10, 12, 13, 14, 15, 16, 17, 18, 19, 10, 11 weeks, 1, 2, 3, 4, 5, 6, 7, 8, 9, 10, 11, 12, 13, 14, 15, 16, 17, 18, 19, 20, 21, 22, 23 months, or one or more years, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more year.

In some aspects, the formicarium may house one or more queens of one or more species. For example, 1, 2, 3, 4, 5, 6, 7, 8, 9, 10, 11, 12, 13, 14, 15, 16, 17, 18, 19, 20, or more queens. Without a queen, there is no mechanism for a colony to grow and develop, which means the ants in the colony may slowly die off without a queen.

In some aspects, the top layer, central nest, central nest components, base plate, module, formicarium, etc., may be in one or two colors, for example, red, pink, blue, yellow, green, orange, white, black, any primary or secondary color, tinted, opaque, transparent, clear, etc., and any combination thereof.

In some aspects, the solution to secure the formicarium together may be by the using M2×18 mm screws. These screws cause the correct amount of tension between the plates, which may control the amount of capillary action for hydration from the hydration ports to flow through the rest of the formicarium.

Method of making and using the formicarium of the disclosure herein may include one or more steps from the following:

Assembly of the standard Formicarium without sand:
a. inserting 12 M2×18 hex nut head bolts in the top layer in the appropriate holes,
b. using a flat cutting board or another similar flat object, place this flat object on the upper surface of the top plate, keeping the bolts in place, and then flipping upside down,
c. adding the middle layer, the central nest, until the three complete layers of middle components are properly positioned. These parts may slide over the M2 bolts now protruding upward,
d. filling the hydration ports with cotton. ⅓ or 0.25 gm of a standard cotton ball may fill each hydration port. The cotton in the hydration ports may be up to 5 gm, for example, 0.01, 0.2, 0.3, 0.4, 0.5, 0.6, 0.7, 0.8, 0.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 5.1, 4.2, 4.3, 4.4, 4.5, 4.6, 4.7, 4.8, 4.9, 50 gm, etc., and any combination thereof. Packing the cotton in a manner that it does not extend above or between the acrylic layers,
e. carefully placing the six Interface connectors in place. These will lock between two middle layer components. Carefully insert this until the Interface meets the top layer firmly,
f. aligning and placing the base plate onto the assembly. The holes may line up allowing for the placement,
g. secure the assembly by attaching the 12 M2 acorn nuts to the bottom of the bolts and tightening these in place,
h. flipping right side up and assembly may be complete. The optional red screen may be placed on top as needed.

Assembly of the standard Formicarium with sand may include one or more steps from:
a. start with the base plate and insert the 12 M2×18 hex head bolt,
b. placing this assembly on a piece of flat material such as a cutting board or other firm, flat surface then flipping over so the assembly is upside down,
c. adding the middle layer, the central nest, until three complete layers of middle components may be properly positioned. These parts may slide over the M2 bolts now protruding upward,
d. placing the six Interface connectors in place. These may lock between the small and large middle layer components. Inserting this until the Interface meets the top layer firmly.
e. Using standard M2 nuts, tightening the sub assembly,
f. Using tape (painter's tape, or scotch tape) to cover the hydration ports,
g. Using tape (painter's tape, or scotch tape) to cover the inside holes on the Interface components,
h. Mixing plaster and water in a ratio of 1 to 1-1.5 such that the mixture may be watery and flows easily,
i. pouring the mixture into the central nest and allowing to sit for 2 minutes,
j. after 2 minutes pouring out the mixture, then filling the nest with fine sand for 2 minutes,
k. pouring out the sand,
l. inspecting the completed coated surface form uniformity and obstruction,
m. removing or scraping thickly coated areas and obstructed areas with a small screwdriver or wet cloth and evening out thinly coated areas with the mixture,
n. removing all taped off areas and cleaning off any overhanging or lumpy parts,
o. filling the hydration ports with cotton. ⅓ or 0.25 gm of a standard cotton ball is sufficient to fill each hydration port. The cotton in the hydration ports may be up to 5 gm, for example, 0.01, 0.2, 0.3, 0.4, 0.5, 0.6, 0.7, 0.8, 0.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 5.1, 4.2, 4.3, 4.4, 4.5, 4.6, 4.7, 4.8, 4.9, 50 gm, etc., and any combination thereof
p. Carefully pack the cotton in so that it does not extend above or between the layers for example acrylic layers.
q. removing all 12 hex nuts while keeping the bolts carefully in place and not allowing internal components to shift,
r. placing the top layer onto the assembled base plate with the central nest, ensuring all components may be aligned, and that no sand or plaster interfere with the fit,
s. placing the two nuts firmly at opposite ends of the so far assembled module (furthest two corners of the hex), hand tightening,
t. carefully flip the assembled module upside down,
u. working with one bolt at a time, removing a bolt from the base plate and inserting it through the top hole,
v. using an M2 acorn nut, carefully hand tighten it, taking care that the acorn nut is on the bottom of the assembly. Hand tighten only and ensure not to overly tighten the assembly as this could fracture the acrylic.
w. repeat the steps t-u until all 10 nuts have been reversed and all 10 acorn nuts are on the bottom,
x. Carefully remove the hex nut from the last two bolts, reverse them as described above in step r and attach a M2 acorn nut on the bottom to complete the final assembly. Again, hand tighten only.
y. Flip right side up and assembly is complete. The optional red screen can be placed on top as needed. Allow the completed assembly to sit and dry for several hours.
z. NOTE: Loose sand may be present within the nest. Small quantities of loose sand is beneficial, but excess sand may be shaken out carefully.

### Comparative Examples

The ant keeper, Michael, needed a formicarium but had limited space. He may benefit from the formicarium of the disclosure herein because the formicarium improves space utilization efficiency due to the hex design. He may expand in any of the six directions. FIG. 9A assembly allows for infinite expandability in 2-dimensional space. Moreover, he may utilize his previous nest and the new modules and allows for the addition of an “Outworld”. To expand this formicarium with additional module/s no tubes or other adapters may be required. Thus, eliminating the possibility of breaking connections and escaped ants. Hydration of the colony may be easily achieved by simply dripping water into the hydration ports directly, thus not removing nor rearranging the apparatus parts, and without causing disturbance in the colony. The amount of hydration and ventilation may also be controlled and customized.

### Detailed Figure Description

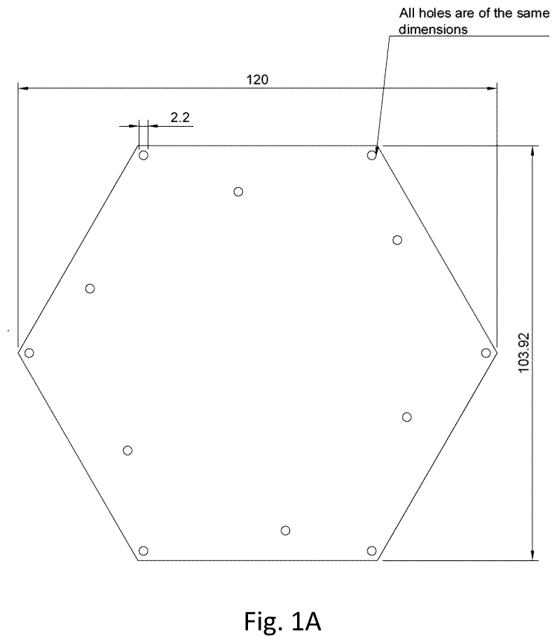

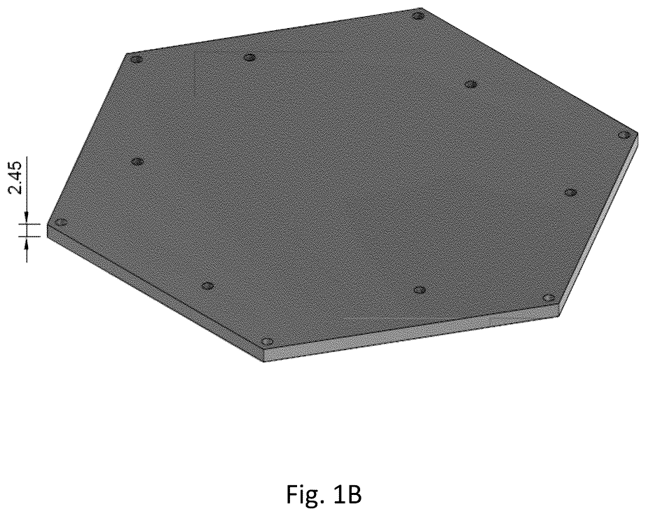

FIG. 1A is top view of the base plate with dimensions and holes locations and arrangements.

FIG. 1B shows an isometric view of the base plate with the plate thickness and location of the holes.

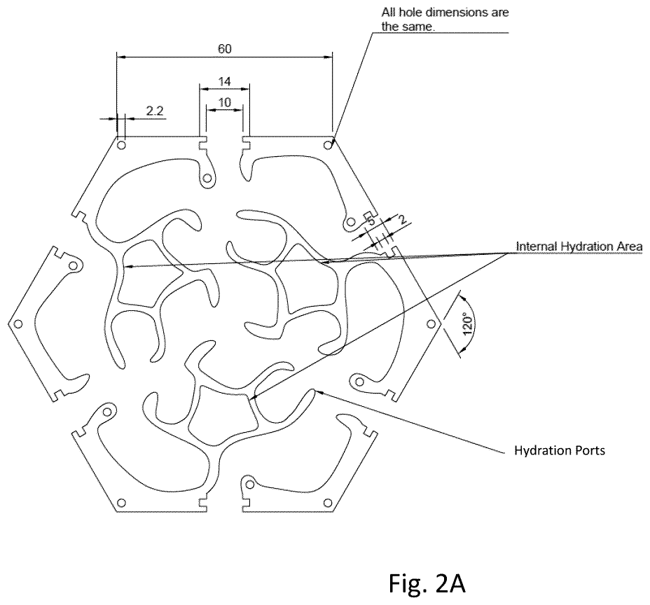

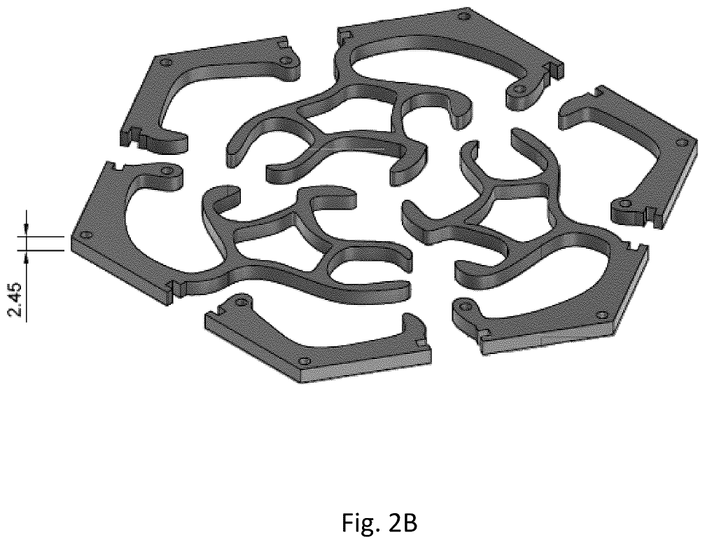

FIG. 2B is a top view of the central nest with dimensions, internal structure, and holes are shown.

FIG. 2 B shows an isometric view of the nest with its thickness and location of the holes and internal structure. The design of the internal structure may be various without impacting the functionality and the overall structure of the formicarium of the disclosure herein.

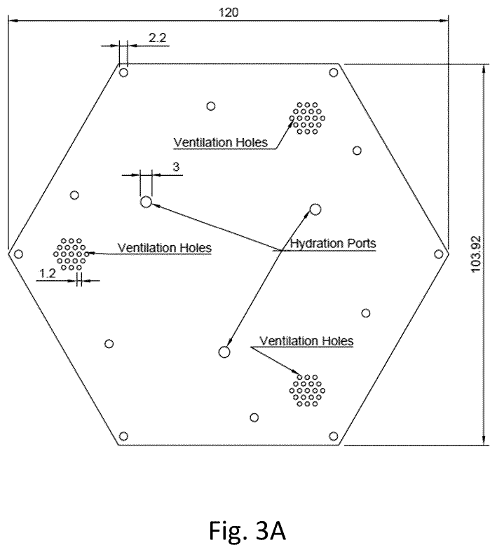

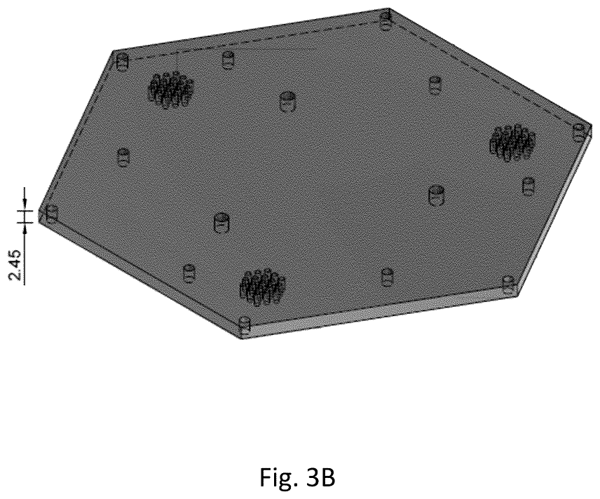

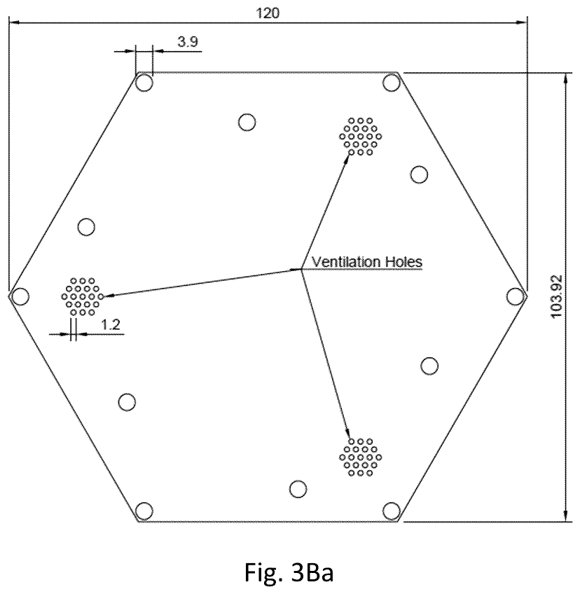

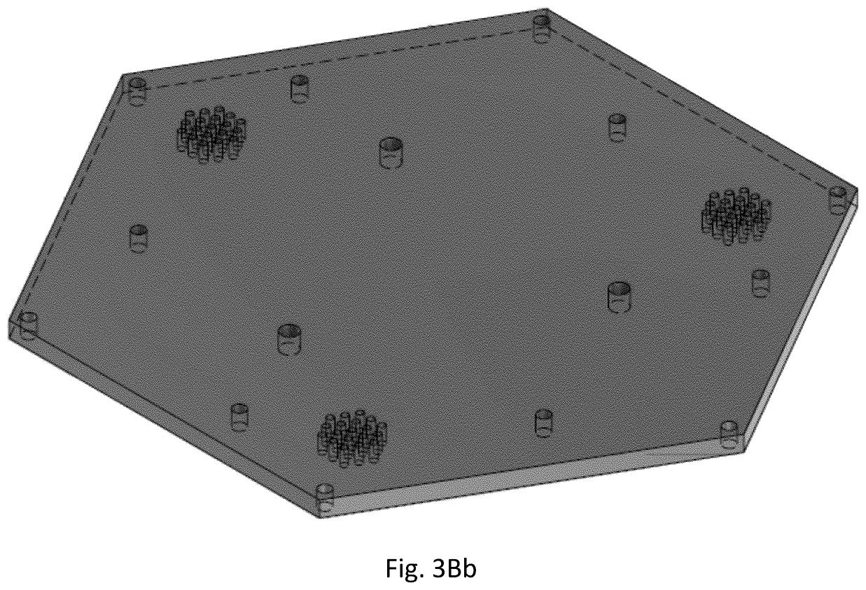

FIG. 3A. is a top view of the top layer with dimensions, location of ventilation holes and hydration ports.

FIG. 3B shows an isometric view with the plate thickness and location of the ventilation holes and hydration ports.

FIG. 3Ba is a top view of red cover layer on the top layer with dimensions, ventilation holes and hydration port's locations.

FIG. 3Bb shows an isometric view with the plate thickness and location of the ventilation holes and hydration ports.

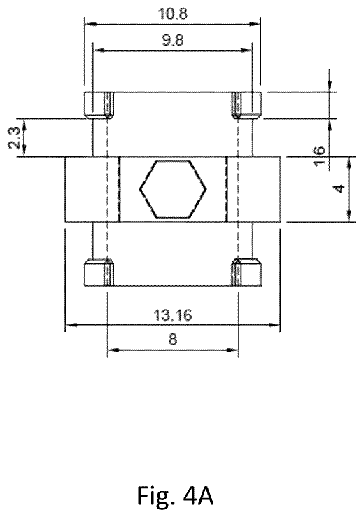

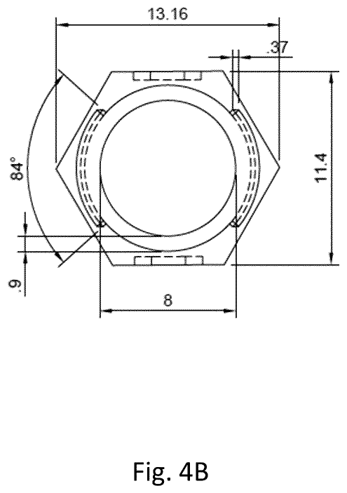

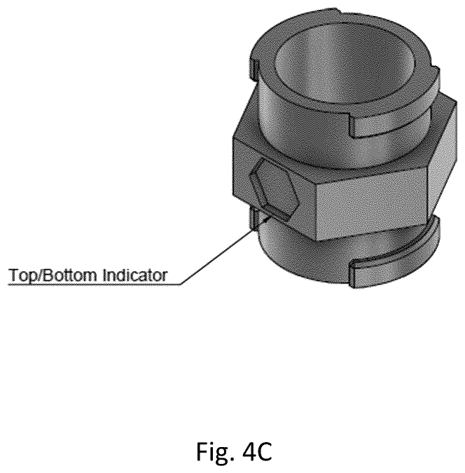

FIG. 4A is a side view of interconnect adapter. Interconnect Adapter may be an adapter designed to interlock at least two formicarium modules together securely. The adapter dimensions are also shown.

FIG. 4B is a top view of interconnect adapter. The interconnect adapter dimensions are also shown.

FIG. 4C is an isometric view of the interconnect adapter.

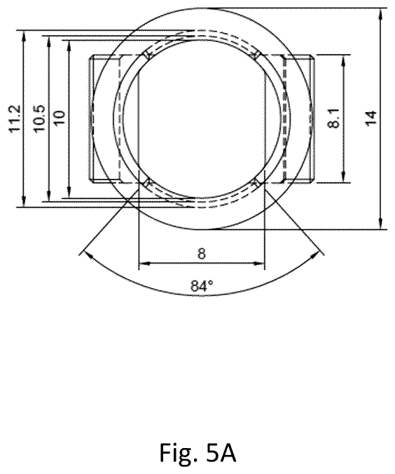

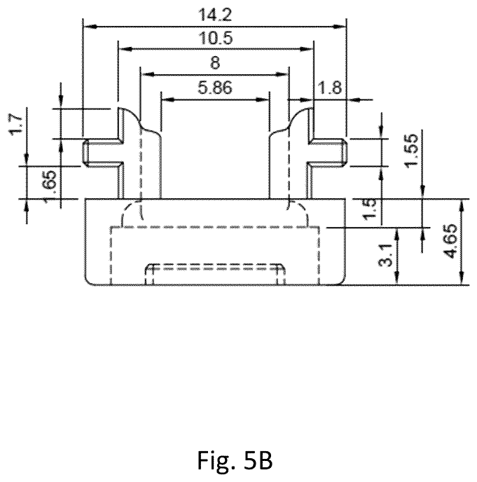

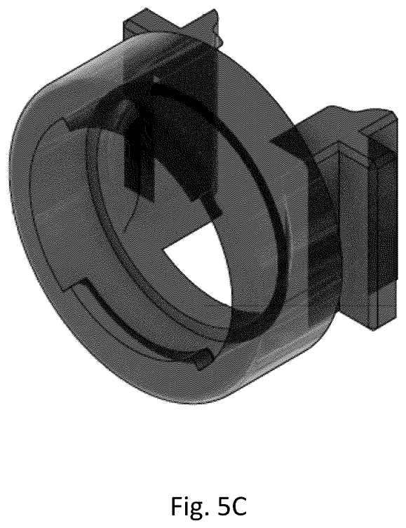

FIG. 5A is a top view of interface connector. The Interface Connectors dimensions are also shown herein. These connectors may allow for the adapters to be used to interlock new formicarium modules, close off the port, or allow the ant keeper to connect the formicarium to third-party formicarium or outworlds.

FIG. 5B is a side view of interface connector. The Interface Connectors dimensions are also shown herein.

FIG. 5C is isometric view of interface connector.

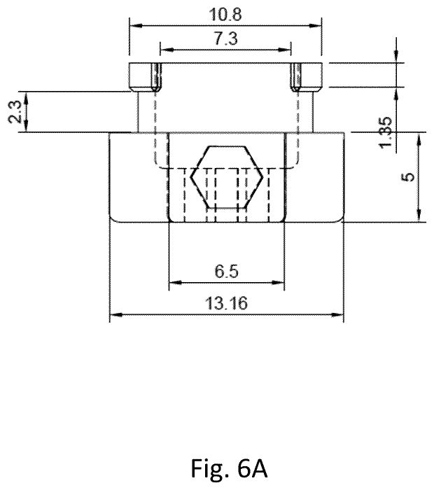

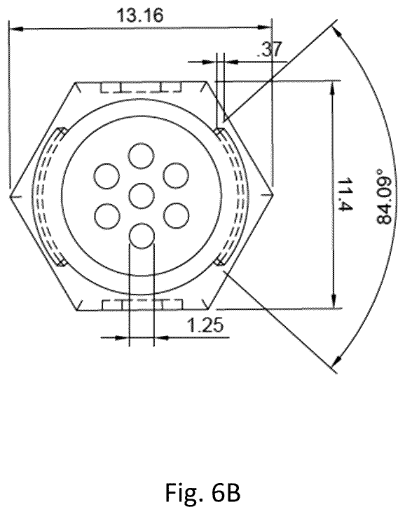

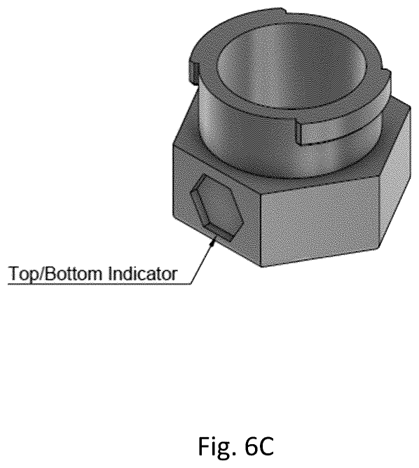

FIG. 6A is a side view of the blocker adapter. The formicarium may allow the keeper to close ports using these Blocker Adapter that prevents ants from escaping while allowing airflow. The blocker adapter dimensions are also shown herein.

FIG. 6B is a top view of the blocker adapter. The blocker adapter dimensions are also shown herein.

FIG. 6C is an isometric view of the blocker adapter.

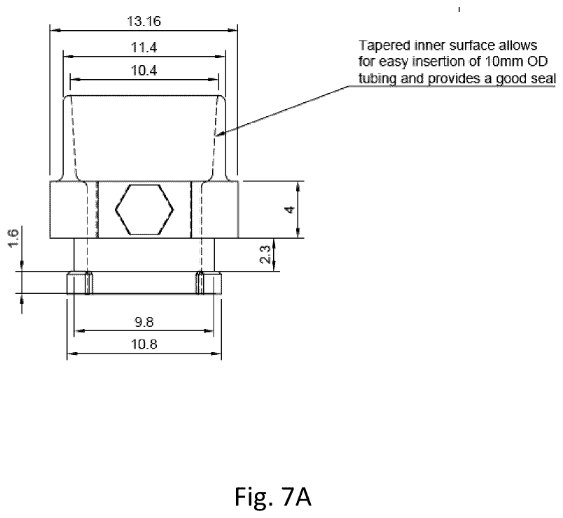

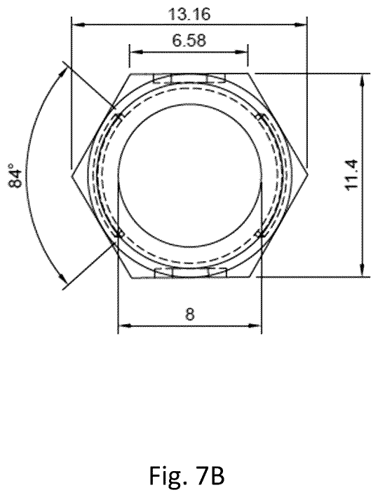

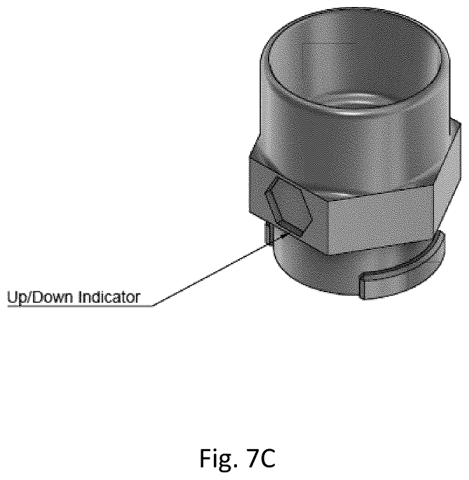

FIG. 7A is a side view of the tube adapter. The tube adapter may be an adapter that allows the ant keeper to connect the Formicarium via a connect up to a 20 mm Outside diameter (OD) tube to formicarium of third-party designs, test tubes, outworlds, or any other device the ant keeper use connected to an outworld, or a formicarium of a 3rd party design. The tube adapter dimensions are shown herein.

FIG. 7B is a top view of the tube adapter. The tube adapter may be an adapter that allows the ant keeper to connect the Formicarium via a connect up to a 20 mm Outside diameter (OD) tube to formicarium of third-party designs, test tubes, outworlds, or any other device the ant keeper use connected to an outworld, or a formicarium of a 3rd party design. The tube adapter dimensions are shown herein.

FIG. 7C is an isometric view of tube adapter.

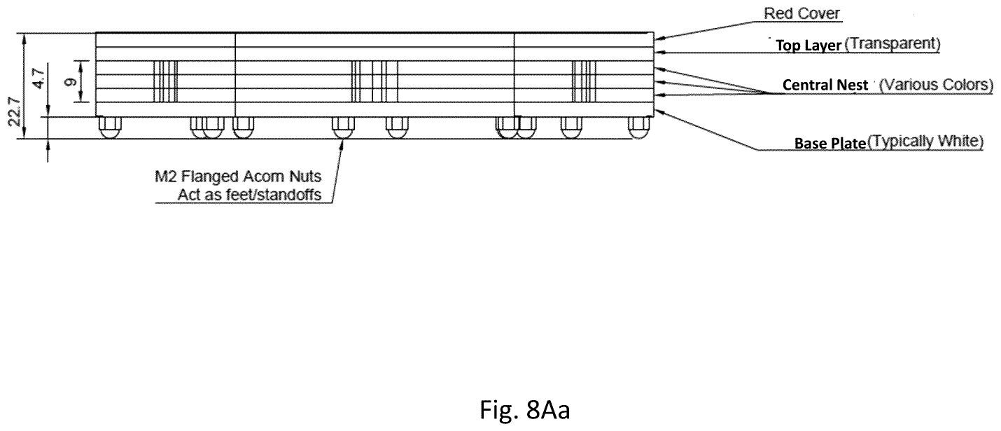

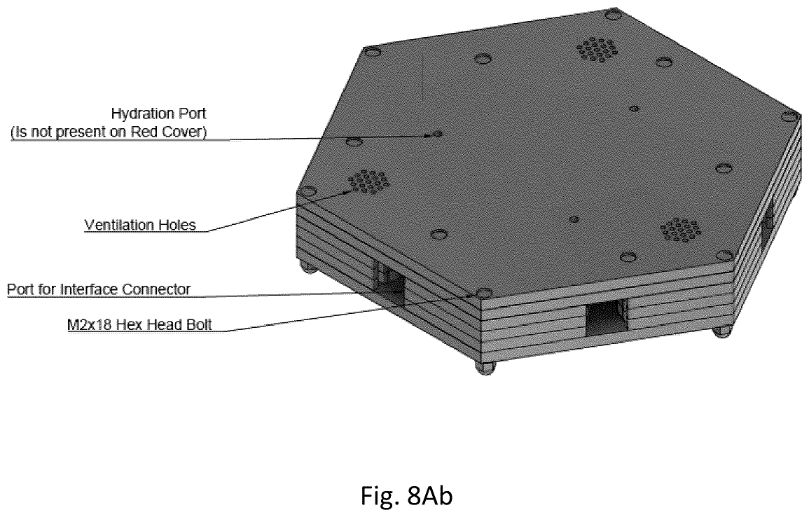

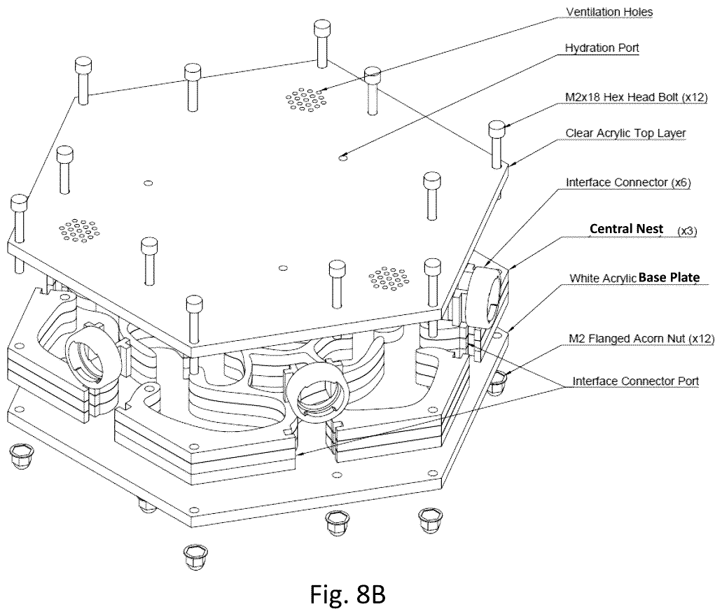

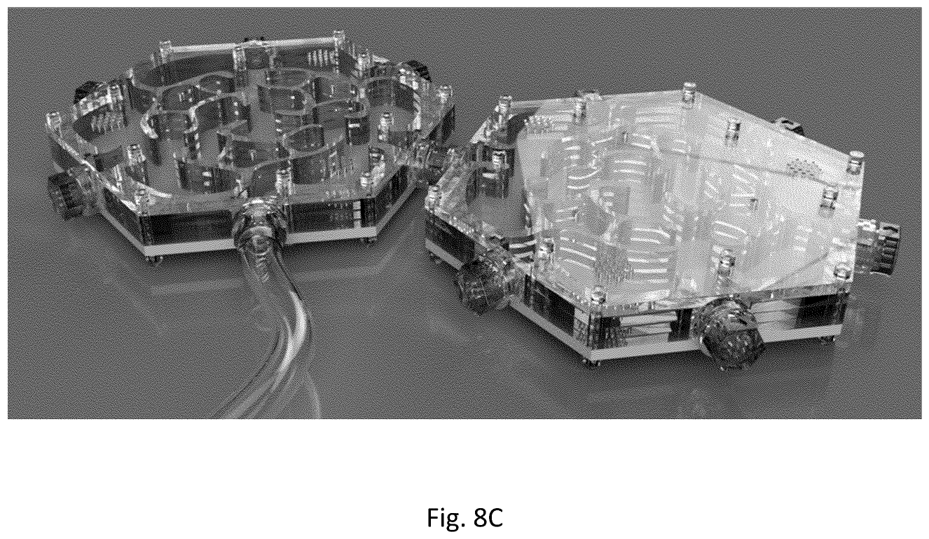

FIG. 8Aa is a side view of an assembled formicarium. In this embodiment, a red cover is shown, which may or may not be optional. The top layer may be transparent, translucent, tinted, clear, opaque, or any combination thereof. at least one top layer. The central nest may be any primary colors or combination thereof, for example, red, blue, green, white, pink, brown, grey, black, etc. The base plate is typically white, light colored, tinted, translucent, opaque, etc., and any combination thereof. This figure shows that the base plate, the central nest, and the top layer are parallel to each other; and the base plate is at the bottom, the at least one central nest is in sandwiched between the base plate and the top layer.

FIG. 8Ab is an isomeric view of an assembled formicarium. This view shows the ventilation holes, port for interface connector, hydration ports, hex head bolts, etc. The hydration ports may or may not be present in the red cover. The formicarium may have 1, 2, 3, 4, 5, 6, 7, 8 or more interface connectors.

FIG. 8B is an isometric view of an assembled formicarium. This view shows ventilation holes, hydration ports, M2×18 hex head bolt (12 in this example), top layer (clear acrylic in this example), interface connectors (6 in this example), central nest layer (3 in this example), inter connectors (6 in this example), bottom base plate (white acrylic in this example), M2 flanged acorn nuts (12 in this example), and interface connector ports.

FIG. 8C is a rendering view of an assembled formicarium. Shown herein are two modules connected to expand the apparatus to two modules, similarly more modules may be added to expand the apparatus. Also shown herein is interface connector may be connected to a test tube adapter to provide a connection to a test tube, which may be connected to an outworld or another formicarium.

It is to be understood that the above description is intended to be illustrative and not restrictive. For example, the above-described embodiments (and/or aspects thereof) may be used in combination with each other. In addition, many modifications may be made to adapt a particular situation, method, system device or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claim.

What is claimed:

1) The formicarium apparatus comprising at least one module, wherein the at least one module comprising: at least one base plate, at least three central nests, and at least one top layer; wherein the at least three central nests are perpendicular to each other;
wherein the at least one base plate, the at least three central nests, and the at least one top layer are parallel to each other;
wherein the at least one base plate is at the bottom, the at least three central nests are sandwiched between the at least one base plate and the at least one top layer;
wherein the at least one base plate and the at least one top layer are attached to the at least three central nest by screws through screw-holes; and
wherein the at least one module further comprising interface connector, hydration ports, and ventilation sections.

2) The apparatus of claim 1, wherein the at least three central nests are identical.

3) The apparatus of claim 1, wherein the at least one module comprising of at least three identical ventilation sections.

4) The apparatus of claim 1, wherein the ventilation section further comprising 19 holes arranged in a hex shape.

5) The apparatus of claim 4, wherein the distance between two adjacent of the 19 holes is 2.1 mm.

6) The apparatus of claim 4, wherein each of the 19 holes is 1.2 mm in diameter.

7) The apparatus of claim 1, wherein the ventilation section has a diameter of 9.6 mm and a height of 8.4 mm.

8) The apparatus of claim 1, wherein the at least one module is hex shaped.

9) The apparatus of claim 1, wherein the hydration ports are at least three; and wherein the water is distributed by capillary action through each hydration port.

10) The apparatus of claim 1, wherein the screw-holes are 2.2 mm in diameter.

11) The apparatus of claim 1, wherein the formicarium has a shelf-life usability from 1 to 30 years.

12) The apparatus of claim 1, wherein the at least three central nest houses ant subpopulations selected one or more from a group consisting of eggs, larvae, pupae, drones, female alates, workers, queen, and any combination thereof.

13) The apparatus of claim 1, wherein the apparatus has an attachable-de-attachable heater;
wherein the heater is at the bottom of the apparatus.

14) The apparatus of claim 1, wherein the at least three central nest comprising of coated sand.

15) The apparatus of claim 14, wherein the coated sand provides walking surface for ants.

16) The apparatus of claim 14, wherein the coated sand provides substrate for Larvae to properly encapsulate into Pupae.

17) The formicarium apparatus comprising at least two modules, wherein each module comprising: at least one base plate, at least three central nest, and at least one top layer;
wherein the at least three central nests are perpendicular to each other;
wherein the base plate, the central nests, and the top layer are parallel to each other;
wherein the base plate is at the bottom, the at least three central nests are sandwiched between the base plate and the top layer;
wherein the base plate and the top layer are attached to the central nests by screws through screw holes;
and wherein the module further comprising interface connector, hydration ports, and ventilation sections; wherein the apparatus further comprising at least one interface connector on each side, and wherein the apparatus is expandable in up to six directions.

18) The apparatus of claim 17, wherein one interface connector of the module interface is connected to a test tube adapter to provide a connection to a test tube.

19) The apparatus of claim 17, wherein the at least two interface connectors on the at least two modules are configured to be connected by at least one interconnect adapter, wherein the two modules are adjacent to each other.

20) The apparatus of claim 17, wherein the at least one interface connector of the module interface is closed off by at least one blocking adapter, wherein the blocking adapter is configured to prevent ant escape.

21) The apparatus of claim 20, wherein the blocking adapter is configured to provide ventilation.

22) The apparatus of claim 17, wherein one interface connector of the module interface is connected to a tube adapter to provide a connection to a 10 mm outside diameter tube.

23) The apparatus of claim 22, wherein the tube is connected to an outworld or another formicarium.
